(19) United States
(12) Patent Application Publication
(10) Pub. No.: US 2012/0119447 A1
(43) Pub. Date: May 17, 2012

(54) Transition Piece Sealing Assembly

(75) Inventors: Mehmet Demiroglu, Schenectady, NY (US); Kevin McMahan, Greer, SC (US); Benjamin Lacy, Greer, SC (US); Neelesh Nandkumar Sarawate, Niskayuna, NY (US); Edip Sevincer, Watervliet, NY (US)

(73) Assignee: GENERAL ELECTRIC COMPANY, Schnectady, NY (US)

(21) Appl. No.: 12/943,981

(22) Filed: Nov. 11, 2010

(51) Int. Cl. F16J 15/02

(52) U.S. Cl. 277/637

(57) ABSTRACT

The present application provides a seating assembly for use with a transition piece and a stage one nozzle of a gas turbine engine. The seating assembly may include a support member positioned between the transition piece and the stage one nozzle and a primary spring element positioned on the support member and in contact with the stage one nozzle. The primary spring element may include a single bend therein.

### FEDERAL RESEARCH STATEMENT

This invention was made with Government support under Contract No. DE-FC26-05NT42643, awarded by the US Department of Energy (DOE). The Government has certain rights in this invention.

### TECHNICAL FIELD

The present application relates generally to gas turbine engines and more particularly relates to improved sealing assemblies for use between a transition piece and a stage one turbine nozzle and similar elements so as to prevent high pressure air leakage therethrough.

### BACKGROUND OF THE INVENTION

Generally described, gas turbine engines may have a sealing assembly positioned between a transition piece(s) and a stage one nozzle and the like. The sealing assembly should prevent high pressure air from leaking into the hot air flow. The sealing assembly may have an outer seal, an inner seal, and a pair of side seals. The inner and the outer seals may have a spring element or a similar structure thereon to ensure adequate contact with the nozzle. Other types of sealing assembly configurations also may be known.

The sealing assembly may accommodate relative movement between the transition piece and the stage one nozzle due to, for example, dynamic pulsing, and the like. The transition piece and the first stage nozzle and/or the nozzle support elements thus may move radially, circumferentially, and axially relative to one another. Moreover, the transition piece and the first stage nozzle may be formed from different materials and subjected to different temperatures during operation. As a result, the transition piece and the stage one nozzle may experience different degrees of thermal growth. This “mismatch” at the interface of the transition piece and the first stage nozzle and/or the nozzle support elements thus requires an effective sealing assembly to contain the combustion products and the pressure differential across the interface, Further, the sealing assembly also should prevent compressor discharge air from bypassing the combustor.

These known sealing assemblies, however, may be prone to wear and tear given the relative movement and thermal growth described above. Such wear and tear inevitably may lead to reduced sealing effectiveness over time. Further, the spring elements used herein also may be prone a loss of memory or resilience if over-compressed. This loss of resilience again may lead to a loss in overall performance and efficiency.

There is thus a desire for an improved sealing assembly for use with a transition piece and a stage one nozzle and the like. Such a sealing assembly preferably may effectively seal the gap between the transition piece and the stage one nozzle while being largely resistant to wear and tear so as to promote long term effectiveness and component lifetime. Moreover, the spring elements used therein preferably may maintain adequate resilience over time.

### SUMMARY OF THE INVENTION

The present application thus provides herein a sealing assembly for use with a transition piece and a stage one nozzle of a gas turbine engine. The sealing assembly may include a support member positioned between the transition piece and the stage one nozzle and a primary spring element positioned on the support member and in contact with the stage one nozzle. The primary spring element may include a single bend therein.

The present application further provides a sealing assembly for use with a transition piece and a stage one nozzle of a gas turbine engine. The sealing assembly may include a support member positioned between the transition piece and the stage one nozzle, a primary spring element positioned on the support member and in contact with the stage one nozzle, and a secondary spring element positioned about the support member. The primary spring element may include a single bend therein.

The present application further provides a sealing assembly for use with a transition piece and a stage one nozzle of a gas turbine engine. The seating assembly may include a number of support. members positioned between the transition piece and the stage one nozzle. Each of the support members may include lateral shim extending towards an adjacent support member to fill a gap therebetween. A spring element may be positioned on each of the support members and in contact with the stage one nozzle.

These and other features and improvements of the present application will become apparent to one of ordinary skill in the art upon review of the following detailed description when taken in conjunction with the several drawings and the appended. claims.

### BRIEF DESCRIPTION OF DRAWINGS

FIG. 1 is a schematic view of a known gas turbine engine.

FIG. 2 is a cross-sectional view of a known transition piece sealing assembly.

FIG. 3 is a side cross-sectional view of a transition piece sealing assembly as may be described herein.

FIG. 4 is a plan view of a section of a primary spring element used with the transition piece sealing assembly of FIG. 3.

FIG. 5 is a plan view of a section of a secondary spring clement used with the transition piece sealing assembly of FIG. 3.

FIG. 6 is a side cross-sectional view of an alternative embodiment of a transition piece sealing assembly as may be described herein.

FIG. 7 is a perspective view of an alternative embodiment of a transition piece sealing assembly as may be described herein.

### DETAILED DESCRIPTION

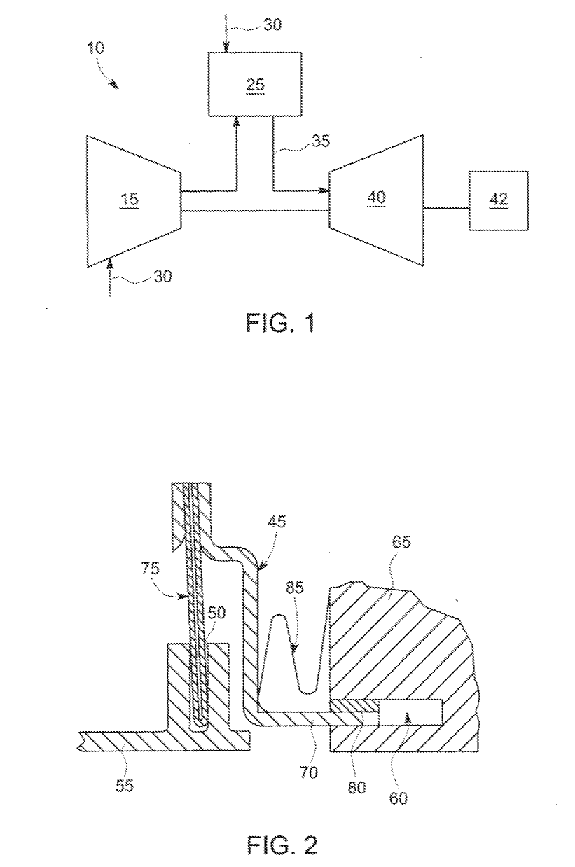

Referring now to the drawings, in which like numerals refer to like elements throughout the several views, FIG. 1 shows a schematic view of a gas turbine engine 10 as may be described herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a compressed flow of fuel 30 and ignites the mixture to create a flow of combustion gases 35. Although only a single combustor 25 is shown, the gas turbine engine 10 may include any number of combustors 25. The flow of combustion gases 35 is delivered in turn to a turbine 40. The flow of combustion gases 35 drives the turbine 40 so as to produce mechanical work. The mechanical work produced in the turbine 40 drives the compressor 15 and an external load 42 such as an electrical generator and the like.

The gas turbine engine 10 may use natural gas, various types of syngas, and/or other types of fuels. The gas turbine engine 10 may be one of any number of different gas turbine engines offered by General Electric Company of Schenectady, New York such as a heavy duty 7FA gas turbine engine and the like. The gas turbine engine 10 may have other configurations and may use other types of components. Other types of gas turbine engines also may be used herein. Multiple gas turbine engines 10, other types of turbines, and other types of power generation equipment also may be used herein together.

FIG. 2 shows a known transition piece sealing assembly 45. The transition piece sealing assembly 45 may be positioned between a groove 50 of a transition piece 55 on one end and a slot 60 of a stage one nozzle 65 on the other. The transition piece sealing assembly 45 may include a support member 70 with a cloth seal 75 at one end. The cloth seal 75 may be positioned about the groove 50 of the transition piece 55. The transition piece sealing assembly 45 further may include a shim 80 for positioning within the slot 60 of the stage one nozzle 65. Other configurations of the sealing assembly 45 may be known.

As described above, the transition piece sealing assembly 45 also may include a spring element 85. The spring element 85 may be positioned about the support member 70 and in contact with the stage one nozzle 65. Use of the spring element 85 generally ensures positive contact between the transition piece sealing assembly 45 and the stage one nozzle 65. Known designs for the spring element 85, however, tend to have somewhat sharp curvatures and/or corners. Specifically, the spring element 85 may be largely “S”-shaped or “Z”-shaped as is shown with multiple bends. These sharp curves or corners may make the spring element 85 susceptible to crushing if overly or repeatedly compressed. Crushing the spring element 85 may result in a loss of memory and resilience and, hence, reduced performance and lifetime.

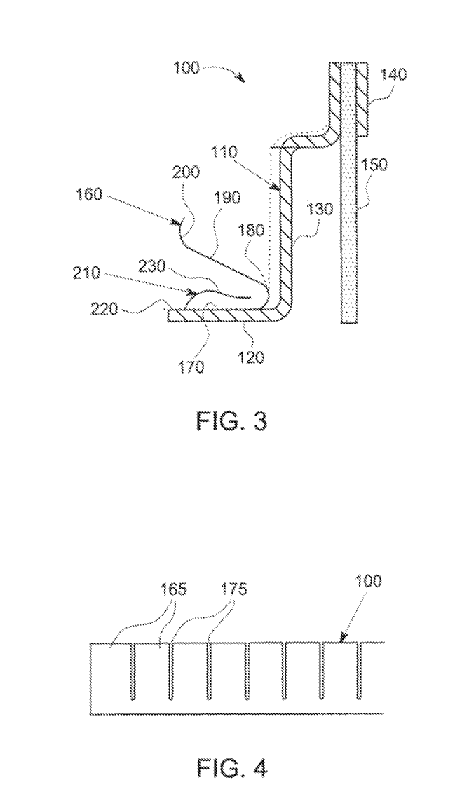

FIGS. 3-5 show a transition piece sealing assembly 100 as may be described. herein. The transition piece sealing assembly 100 may have a somewhat similar support member 110 to that described above. Specifically, the support member 110 may have a horizontal mounting flange 120 at one end that extends to a vertical extension 130 and ends about a pair of sealing flanges 140. A cloth seal 150 may be positioned within the seal flanges 140, The cloth seal 150 may be, for example, a Dutch Twill weave cloth of a high temperature cobalt-based super alloy and the like, Other configurations may be used herein.

The transition piece sealing assembly 100 also may include a primary spring element 160. The primary spring element 160 may be largely U-shaped with a first flat member 170 positioned along the horizontal mounting flange 120, a single U-shaped bend 180 extending therefrom, and a second flat member 190. Further, a vertically extending curve 200 may extend upwardly therefrom. As is shown in FIG. 4, the primary spring element 160 may include a number of shims 165 with small primary spring gaps 175 therebetween. The primary spring element 160 may be made out of a substantially flexible material such as an Inconel X-750 Nickel-based alloy and the like, The shape, size, thickness, and material of the primary spring element 160 may vary.

The primary spring element 160 thus has a simplified profile with a larger curvature and only one bend as compared to the known spring element 85 described above, This shape may result in less corner stresses and, hence, less physical or plastic deformation when crushed and/or otherwise compacted. Further, the primary spring element 160 may have improved memory and resilience so as to recover its original shape after undergoing deformation at high temperatures.

The transition piece sealing assembly 100 also may include a secondary spring element 210. The secondary spring element 210 may be attached to the first flat member 170 of the primary spring element 160 or the horizontal mounting flange 120.

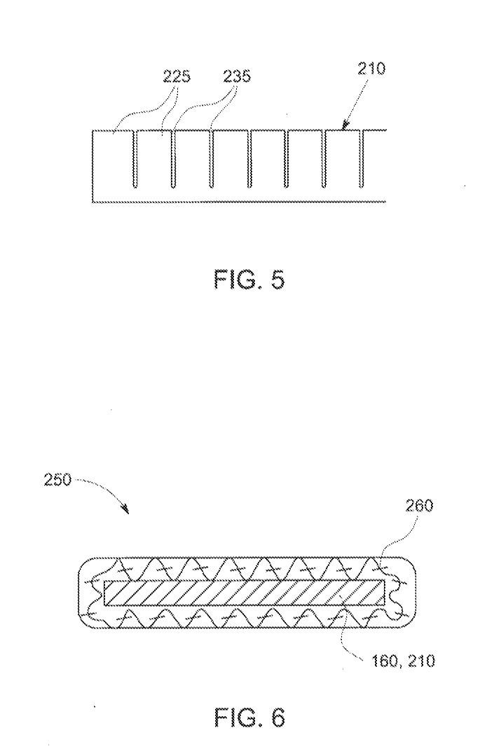

The secondary spring element 210 may have a flat end 220 and a reversed upward curve 230 extending therefrom. As is shown in FIG. 5, the secondary spring element 210 also may include a number of shims 225 with small secondary spring gaps 235 therebetween. The secondary spring element 210 also may be made out of a substantially flexible material such as an Inconel X-750 Nickel-based ahoy and the like. The shape, size, thickness, and material of the secondary spring element 220 may vary.

The secondary spring element 210 thus provides additional contact support and also fills the gap between the stage one nozzle 65 and the support member 110. The primary spring gaps 175 and secondary spring gaps 235 may be staggered with respect to each other so as to prevent leakage therethrough. The primary spring element 160 may be used with or without the secondary spring element 210. Other configurations may be used herein.

FIG. 6 shows a portion of a further embodiment of a transition piece sealing assembly 250. The transition piece sealing assembly 250 may be similar to the transition piece sealing assembly 100 described above but with a cloth layer 260 wrapped around one or both of the primary spring element 160 and the secondary spring element 210. The cloth layer 260 may be, for example, a Dutch. Twill weave cloth of a high temperature cobalt-based super alloy and the like. The cloth layer 260 may make the primary spring element 160 and the secondary spring element 210 somewhat less compliant, but the cloth layer 260 also provides additional wear resistance. The cloth layer 260 may wrap around the primary spring element 160 and/or the secondary spring element 210 in whole or in part. The overall design of the transition piece sealing assembly 250 thus may be optimized to achieve the correct balance between flexibility and wear resistance. Other configurations may be used herein.

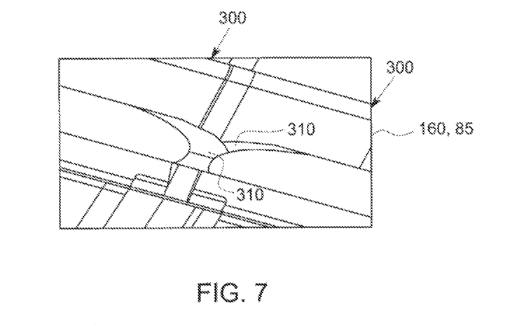

FIG. 7 shows a further embodiment of a transition piece sealing assembly 300. The transition piece sealing assembly 300 may be largely similar to the transition piece sealing assembly 100 described above. In this embodiment, one or more lateral shims 310 may extend on one end thereof about the primary spring element 160. The lateral shims 310 may extend outwardly so as to close the gap between adjacent transition piece sealing assemblies 100. The lateral shims 310 may overlay higher on one side of the transition piece 45 than the other so as to allow ease of installation (except for the last transition piece 45 to be installed). The lateral shims 310 also may be used with the spring element 85 described above. Other configurations may be used herein.

It should be apparent that the foregoing relates only to certain embodiments of the present application and that numerous changes and modifications may be made herein by one of ordinary skill in the art without departing from the general spirit and scope of the invention as defined by the following claims and the equivalents thereof

We claim:

1. A sealing assembly for use with a transition piece and a stage one nozzle of a gas turbine engine, comprising:
a support member positioned between the transition piece and the stage one nozzle; and
a primary spring element positioned on the support member and in contact with the stage one nozzle;
wherein the primary spring element comprises a single bend therein,

2. The sealing assembly of claim 1, wherein the support member comprises a mounting flange and a vertical extension.

3. The sealing assembly of claim 2 wherein the primary spring element is positioned on the mounting flange.

4. The sealing assembly of claim 1, wherein the support member comprises a pair of sealing flanges and wherein a cloth seal is positioned therebetween.

5. The sealing assembly of claim 1, wherein the primary spring element comprises a plurality of shims with a plurality of gaps therebetween.

6. The sealing assembly of claim 1, wherein the primary spring element comprises a first flat member and a second flat member with the single bend therebetween.

7. The sealing assembly of claim 6, wherein the primary spring element comprises a vertically extending curve adjacent to the second flat member.

8. The sealing assembly of claim 1, wherein the primary spring element comprises a cloth layer thereon.

9. The sealing assembly of claim 1, further comprising a secondary spring element positioned about the support member,

10. The sealing assembly of claim 9, wherein the secondary spring element comprises a plurality of shims with a plurality of gaps therebetween.

11. The sealing assembly of claim 9, wherein the secondary spring element comprises a flat end and a reversed upward curve.

12. The sealing assembly of claim 9, wherein the secondary spring element comprises a cloth layer thereon.

13. The sealing assembly of claim 1, further comprising a plurality of support members and with each of the plurality of support members comprising a lateral shim extending towards an adjacent support member.

14. A sealing assembly for use with a transition piece and a stage one nozzle of a gas turbine engine, comprising:
a support member positioned between the transition piece and the stage one nozzle;
a primary spring element positioned on the support member and in contact with the stage one nozzle;
wherein the primary spring element comprises a single bend therein; and
a secondary spring element positioned about the support member.

15. The sealing assembly of claim 14, wherein the primary spring element comprises a first flat member and a second flat member with the single bend. therebetween,

16. The sealing assembly of claim 15, wherein the primary spring element comprises a vertically extending curve adjacent to the second at member.

17. The sealing assembly of claim 14, wherein the primary spring element and/or the secondary spring element comprise a cloth layer thereon.

18. The sealing assembly of claim 14, wherein the secondary spring element comprises a flat end and a reversed upward curve.

19. The sealing assembly of claim 14, further comprising a plurality of support members and with each of the plurality of support members comprising a lateral shim extending towards an adjacent support member.

20. A sealing assembly for use with a transition piece and a stage one nozzle of a gas turbine engine, comprising:
a plurality of support members positioned between the transition piece and the stage one nozzle;
wherein each of the plurality of support members comprises a lateral shim extending towards an adjacent support member to a gap therebetween; and
a spring element positioned on each of the plurality of support members and in contact with the stage one nozzle.
